(19) United States
(12) Patent Application Publication
(10) Pub. No.: US 2025/0011555 A1
(43) Pub. Date: Jan. 9, 2025

(54) HIGH-STRENGTH FLAME-RETARDANT MXENE/PHOSPHORYLATED CELLULOSE FIBRIL COMPOSITE FILM AND PREPARATION METHOD THEREOF

(71) Applicant: SUZHOU JUFENG ELECTRICAL INSULATION SYSTEM CO., LTD., Suzhou (CN)

(72) Inventors: Shineng LI, Suzhou (CN); Cheng ZHOU, Suzhou (CN); Yu XIA, Suzhou (CN)

(21) Appl. No.: 18/706,421

(22) PCT Filed: Jul. 13, 2023
(86) PCT No.: PCT/CN2023/107107

§ 371 Date: May 1, 2024

(30) Foreign Application Priority Data
Sep. 23, 2022 (CN) 202211164435.0

(51) Int. Cl. C08J 5/18; C08L 101/02; C09D 101/02

(52) U.S. Cl. CPC C08J 5/18; C08L 101/02; C09D 101/02; C08J 2301/02; C08J 2405/08; C08L 2201/02; C08L 2203/16

(57) ABSTRACT

The present application provides a high-strength flame-retardant MXene/phosphorylated cellulose fibril composite film and a preparation method thereof, belonging to the technical field of polymer materials. Dispersing uniformly phosphorylated cellulose nanofibrils into aqueous solution, adding chitosan and MXene and mixing evenly, drying to obtain the composite film. The present application utilizes MXene and introduces chitosan to enhance the flame-retardant performance and thermal stability of phosphorylated cellulose nanofibrils, meanwhile, strengthen the interaction between MXene and phosphorylated cellulose nanofibrils, combining the nano-enhancement effect of MXene can improve the mechanical properties of composite film. The phosphorylated cellulose fibril composite film prepared by MXene and chitosan co-modified not only has excellent flame-retardant properties, but also improves its mechanical properties. The film can be used as flame-retardant coating to effectively protect the combustible substrate/device in burst state (flame or high temperature).

### TECHNICAL FIELD

The invention belongs to the technical field of polymer materials, specifically relates to a high-strength flame-retardant MXene/phosphorylated cellulose fibril composite film and preparation method thereof.

### BACKGROUND

Since its birth, thin film materials have been widely used and developed in many fields such as agriculture, national defense, aerospace, electronics industry and so on. With the rapid development of society, people have put forward higher and higher performance requirements for film materials, such as high mechanical properties, flame retardant or high temperature resistance. Although traditional polymer-based films (Polyethylene or Polypropylene) have good mechanical properties, they are generally poor in flame retardancy, so they cannot meet the performance requirements in some special fields. The general method is to add flame retardants such as Mg(OH)₂, zinc borate and ammonium polyphosphate to the matrix (Chinese patent CN105473333B, CN106554543B and CN106003887B) to improve its flame-retardant properties, but the higher additive amount will cause the mechanical properties of the film material decay and is not suitable for industrialization. Polyvinyl chloride film has good flame-retardant properties, but there are problems of poor mechanical stability and residual halogen and other harmful substances. Chinese patent CN111607218A discloses a method for preparing a polyurethane flame-retardant film, using aliphatic TPU particles as the matrix and polyurethane prepolymer as the flame-retardant crosslinker. (obtained from the polymerization of dicyclohexylmethane diisocyanate and polyether glycol), through blending melting, casting and cooling and other processes to obtain polyurethane flame-retardant film. However, the tensile strength of the film is only 20-45 MPa, which seriously restricts its further development and practical application. In addition, polymer-based films are also difficult to degrade, which will have a huge impact on the natural environment. Therefore, the development of a green environmental protection, high mechanical properties of flame-retardant film material is urgently needed.

In recent years, biomass-base (chitosan, sodium alginate, etc.) film materials have attracted extensive attention due to their excellent mechanical properties, green environmental protection, good film-forming property and biocompatibility. The existing technology provides a preparation method for a highly transparent flexible flame retardant film, which relates to the field of flexible flame retardant film, including the following steps: preparing intermediate A intermediate B and intermediate C, respectively; adding PVA to distilled water and heating up to 90-95° C. and stirring for 5-10 min to obtain PVA solution with a certain mass concentration, cooling down to 50-60° C., then adding intermediate A and C and keeping warm and stirring for 30-40 min, adding nanocellulose and natural clay and continue to stir for 1-3 h, and then painting the film on the flat glass plate after vacuum defoaming. The glass plate is transferred to the oven at 40-50° C. for 2-5 h, heating to 80-85° C. and curing for 5-10 h to obtain the highly transparent flexible flame-retardant film, however, its tensile strength is weak (less than 15 MPa).

Cellulose is the most widely distributed and the most abundant polysaccharide in nature, and its unique molecular structure (the main chain structure has a large number of hydroxyl groups) makes its molecular chain interaction strong, so the physical and chemical properties are relatively stable. A series of derivatives, including cellulose nanocrystalline, cellulose nanocrystals and cellulose nanofibril, can be obtained by physical or chemical treatment. Cellulose nanofibril can be prepared by solvent casting due to their high ratio of length to diameter, but lack of flame retardancy makes them unable to meet the practical application.

The introduction of specific groups such as phosphorous groups through chemical pretreatment of cellulose is limited to improve its flame retardancy, and it cannot achieve long-term flame retardancy (less than 6 s). Previous studies have shown that phosphorylation and lignin can slightly improve the flame-retardant properties of cellulose nanofibril, but the mechanical properties are still not ideal (the tensile strength is less than 50 MPa). The Chinese patent CN112321861A provides a phosphorylated cellulose nanofiber/black scale quantum dot composite flame-retardant film, but its preparation process (including soaking, drying, curing, etc.) is complex and not good for market application.

In summary, although cellulose based flame-retardant films have achieved certain results, there are still unsatisfactory performance parameters (mechanical and flame-retardant properties), which greatly restricts their further application and development. Therefore, how to develop a simple and effective construction strategy to improve the mechanical and flame-retardant properties of flame-retardant film materials is still a challenge.

### SUMMARY

In view of this, the purpose of the present invention is to provide a preparation method of high-strength flame-retardant MXene/phosphorylated cellulose filament composite film to solve the technical problems existing in the prior art.

To achieve the above purpose, the technical solutions of the present application are as follows:

A high-strength flame-retardant MXene/phosphorylated cellulose fibril composite film and a preparation method thereof, comprising the following steps: Mixing phosphorylated cellulose nanofibril solution with chitosan solution, and adding MXene solution to obtain precursor solution; then preparing the precursor solution into a film to obtain the high-strength flame-retardant MXene/phosphorylated cellulose fibril composite film.

In the present application, the solvent in the chitosan solution is acetic acid or hydrochloric acid aqueous solution, and the concentration of the solvent is 0.2-3.0 vol %, the solvent in the phosphorylated cellulose nanofiber solution and the MXene solution is water, the mass ratio of chitosan, phosphorylated cellulose nanofibril and MXene is (1-10):(10-50):(50-200), preferably (1-8):(13-35):(70-150), and further preferably (1-6):(13-25):(70-120).

In the present application, mixing the phosphorylated cellulose nanofibrils solution with the chitosan solution for 0.1-1 hour, then adding the MXene solution and reacting at 20-30° C. for 0.1-1 hour to prepare the precursor solution, the precursor solution is then vacuum dried to form a film to obtain a high-strength flame-retardant MXene/phosphorylated cellulose fibril composite film.

In the present application, using titanium carbide aluminum as raw material to prepare the MXene, using cellulose pulp board, phosphate and organic nitrogen compounds as raw material to prepare the phosphorylated cellulose nanofibrils, the molecular weight of the chitosan is 500-350000, and the degree of deacetylation is 75-98%. Specifically, using titanium-carbide aluminum as raw material, and in the presence of the lithium fluoride and hydrochloric acid to prepare the MXene, the phosphate is one of disodium hydrogen phosphate, diammonium hydrogen phosphate and dipotassium hydrogen phosphate or a combination; the organonitrogen compound is urea.

As an example, the specific steps of preparation method of high-strength flame-retardant MXene/phosphorylated cellulose fibril composite film of the present application including:
(1) By weight, at room temperature, adding 1-5 parts of chitosan to the container, subsequently adding 50-250 parts of acetic acid or hydrochloric acid solution to form a uniform solution after mixing; the purpose of introducing dilute acid is to promote the effective extension of chitosan molecular chain and obtain a uniform reaction system;
(2) By weight, at room temperature, adding 40-80 parts phosphorylated cellulose nanofibril to the container, then adding 50-150 parts of deionized water to mix to form a uniform solution;
(3) By weight, at room temperature, adding 0.5-10 parts of MXene to the container, then adding 1-10 parts of deionized water to mix to form a uniform solution;
(4) At room temperature, adding the chitosan solution of step (1) to the solution obtained in step (2) and stirring well, subsequently reacting at room temperature for 0.2-0.8 hour to obtain evenly dispersed mixture of cellulose nanofibril and chitosan;
(5) Adding the MXene solution in step (3) to the solution obtained in step (4), and then reacting at 20-35° C. for 0.1-1 hour to obtain the precursor solution;
(6) Placing the obtained precursor solution in the mold, putting in a vacuum oven at 40-50° C. and treating for 72-96 hour to prepare the flame-retardant composite film.

In the above preparation method, using phosphorylated cellulose nanofibrils, the method is environmentally friendly, simple and feasible, and has high yield; At the same time, the introduction of phosphorous groups can not only improve the film-forming property, dimensional stability and dispersibility of cellulose nanofibrils, but also interact multiple times with the amino and hydroxy on the chitosan molecular chain and the hydrophilic functional groups on the surface of MXene, which is helpful to improve the mechanical properties of the composite films.

In the above preparation method, on the one hand, the introduction of chitosan can enhance the interrelation between phosphorylated cellulose nanofibrils, improve the integrity and mechanical properties of the network structure; on the other hand, the excellent film-forming property of chitosan simplifies the preparation process of thin film materials and is easy to be industrialized; moreover, the introduction of MXene can enhance the mechanical properties of the composite film (nano enhancement effect), but also further enhance the flame-retardant properties. The interaction of the three main raw materials makes the composite film prepared by the present application have excellent and balanced mechanical properties (the tensile strength: 159.3 MPa, the fracture energy: 8.1 MJ·m⁻³), and excellent flame-retardant property.

According to the above technical scheme, compared to existing technology, the present application provides a high-strength flame-retardant MXene/phosphorylated cellulose nanofibrils composite film and a preparation method thereof, possessing the following excellent effects:

The present application can improve the water dispersibility of the cellulose nanofibrils by phosphorylation, and give it the flame-retardant property; using the nano-enhancement effect of MXene and the active functional groups of chitosan (amino and hydroxyl) to improve simultaneously the mechanical and flame-retardant properties of phosphorylated cellulose nanofibril composite films. Chitosan can not only form hydrogen bond with hydroxyl and phosphorous groups on phosphorylated cellulose nanofibrils to bridge the nanofibril network, but also enhance the interaction of MXene and nanofibrils, thereby promoting substantial enhancement of mechanical properties. The obtained composite film prepared by the present application has excellent mechanical property, outstanding flame-retardant property, and is suitable for the field of flame-retardant coating in the future.

### BRIEF DESCRIPTION OF THE DRAWINGS

In order to more clearly state the embodiment of the present application or the technical solutions of the prior art, the following is a brief introduction of the drawings required to be used in the description of the embodiment or the prior art. Obviously, the drawings in the description below are only embodiments of the present application. For ordinary technicians in the field, without creative labor, additional drawings may also be obtained based on the drawings provided.

FIG. 1 shows the stress-strain curves of the composite film for Comparative example 1-3, Embodiment 3 and 6 of the present application.

FIG. 2 shows cross-section SEM of the high-strength flame retardant MXene/phosphorylated cellulose fibril composite film synthesized in Embodiment 3 of the present application.

FIG. 3 shows the comparative digital photographs of high-temperature treatment of high-strength flame-retardant MXene/phosphorylated cellulose fibril composite film synthesized by Embodiment 3 and Comparative example 1.

FIG. 4 shows the digital photographs of the combustion process of high-strength flame-retardant MXene/phosphorylated cellulose fibril composite film synthesized by Comparative example 1, Comparative example 2 and Embodiment 3 of the present application.

FIG. 5 shows the heat release rate and total heat release of high-strength flame-retardant MXene/phosphorylated cellulose fibril composite film synthesized from Comparative example 1 and Embodiment 3.

### DETAILED DESCRIPTION

The technical solutions in the embodiments of the present application will be clearly and completely described below with reference to the accompanying drawings in the embodiments of the present application. Obviously, the described embodiments are only some, not all of the embodiments of the present application. Based on the embodiments of the present application, all other embodiments obtained by those of ordinary skill in the art without creative efforts fall within the scope of protection of the present application.

The embodiment of the present application provides a preparation method for high-strength flame-retardant MXene/phosphorylated cellulose fibril composite film. By weight, at room temperature, adding 1-5 parts of chitosan to the container, then adding 50-250 parts of acetic acid or hydrochloric acid solution to mix to form a uniform solution; by weight, at room temperature, adding 40-80 parts phosphorylated cellulose nanofibril to the container, then adding 50-150 parts of deionized water to mix to form a uniform solution; by weight, at room temperature, adding 0.5-10 parts of MXene to the container, then adding 1-10 parts of deionized water to mix to form a uniform solution; by weight, at room temperature, adding the chitosan solution to the phosphorylated cellulose nanofibrils solution, then reacting at room temperature for 0.5 hour to obtain homogeneous solution of phosphorylated cellulose nanofibrils and chitosan, adding the MXene solution to the homogeneous solution, then reacting at 20-35° C. for 0.5 hour to obtain the homogeneous solution of phosphorylated cellulose nanofibrils and chitosan and MXene, the obtained composite solution is placed in the mold, putting in a vacuum oven at 40-50° C. to dry for 72-96 hour to prepare the flame-retardant composite film.

The preparation method of MXene in the present application is:
1) Mixing lithium fluoride with 7-9 mol/L hydrochloric acid to form a solution with a concentration of 5-10 g/ml;
2) Adding 1.0-2.5 g MAX-Ti₃AlC₂ to the solution of step 1) under stirring, adjusting the heating temperature to 30-50° C., stirring for 20-30 hour;
3) Washing and centrifuging the suspension obtained in step 2) with deionized water for several times until the pH of the supernatant is neutral, then adding ethanol to clean and centrifuge, and the obtained precipitate was ultrasonically dispersed again with deionized water to obtain MXene.

In the present application, the preparation method of phosphorylated cellulose nanofibrils is as follows: by mechanical method, crushing 10-15 g cellulose pulp board to obtain flocculent raw materials, then mixing it with 400-800 ml of deionized water, 20-25 g of phosphate and 40-45 g of urea for 30-60 min; the obtained mixture is placed in the oven at 40-100° C. to treat, then transferring to 140-180° C. for heating and curing for 10-30 min; after cooling, the cured products are dispersed in deionized water, and using sodium hydroxide solution to adjust the pH of the system to 10-13, then still standing for 1-2 hour; then washing the product with deionized water for several times to neutral, the obtained suspension with ultrafine grinder at 1000-1500 rpm to grind to obtain phosphorylated cellulose nanofibrils, adjusting the concentration to 0.2-0.5 wt %.

In order to better understand the present application, the following embodiments of the present application are further elaborated, but cannot be understood as the limitation of the present application, and some non-essential improvements and adjustments made by technicians in the field according to the contents of the present application are also considered to fall within the scope of protection of the present application. The raw material of the present application is a conventional product, and the specific preparation operation and test are conventional techniques. The weight average molecular weight of the chitosan used is 500-350000, and the degree of deacetylation is 75-98%.

### Embodiment 1

1) The preparation method of phosphorylated cellulose nanofibril is as follows: using 10 g of cellulose pulp board as raw material, by mechanical grinding to obtain flocculent raw material, adding 400 ml of deionized water, 20 g of diammonium hydrogen phosphate and 40 g of urea and mechanically stirring for 30 min, the obtained mixture is placed in the oven at 40° C. to dry, then at 140° C. to heat continuously for 10 min to cure, the cured product is dissolved in 1 L of deionized water, using 1 mol/L of sodium hydroxide solution to adjust the pH of the solution to 10 and still standing for 1 hour. Subsequently, washing the above product with deionized water several times to neutral, adjusting the concentration to 0.4 wt %, the suspension by using a centrifugal ultrafine grinder at 1000 rpm to grind for 1 hour to obtain nano-sized particles of phosphorylated cellulose nanofibrils.

2) At room temperature, adding 0.5 g of chitosan (the weight-average molecular weight is 5000, the degree of deacetylation is 82%) to 25 ml of acetic acid solution (0.2 vol %), continuously stirring for 0.5 hour, and then still standing.

3) By weight, at room temperature, adding 40 g of phosphorylated cellulose nanofibrils aqueous solution to the container, then adding 100 ml of deionized water to mix to form uniform solution.

4) By weight, at room temperature, adding 0.9 g of MXene to the container, and adding 9 ml of deionized water to mix to form uniform solution.

5) At room temperature, taking 102 ml of the blended solution of step 3), adding 6 ml of the chitosan solution of step 2) to stir for 0.5 hour to obtain the homogeneous solution of cellulose nanofibrils and chitosan.

6) Adding the MXene solution in step 4) to the solution obtained in step 5), then at 20° C. to react for 0.5 hour to obtain the homogeneous solution of phosphorylated cellulose nanofibrils, chitosan and MXene.

7) The obtained composite solution is placed in the mold, putting in a vacuum oven at 40° C. to dry for 72 hour to prepare the high-strength flame-retardant MXene/phosphorylated cellulose nanofibrils composite film.

### Embodiment 2

1) The preparation method of phosphorylated cellulose nanofibril is as follows: using 11 g of cellulose pulp board as raw material, by mechanical grinding to obtain flocculent raw material, adding 500 ml of deionized water, 21 g of diammonium hydrogen phosphate and 41 g of urea and mechanically stirring for 40 min, the obtained mixture is placed in the oven at 50° C. to dry, then at 150° C. to heat continuously for 10 min to cure, the cured product is dissolved in 1 L of deionized water, using 1 mol/L of sodium hydroxide solution to adjust the pH of the solution to 11 and still standing for 1 hour. Subsequently, washing the product with deionized water several times to neutral, adjusting the concentration to 0.3 wt %, the suspension by using centrifugal ultrafine grinder at 1100 rpm to grind to obtain nano-sized particles of phosphorylated cellulose nanofibrils.

2) At room temperature, adding 0.5 g of chitosan (the weight-average molecular weight is 7500, the degree of deacetylation is 79%) to 125 ml of acetic acid solution (1 vol %), continuously stirring for 0.5 hour, and then still standing.

3) By weight, at room temperature, adding 80 g of phosphorylated cellulose nanofibrils aqueous solution (0.3 wt %) to the container, then adding 100 ml of deionized water to mix to form uniform solution.

4) By weight, at room temperature, adding 1.8 g of MXene to the container, then adding 18 ml of deionized water to mix to form uniform solution.

5) At room temperature, taking 96 ml of the blended solution of step 3), adding 8 ml of the chitosan solution of step 2) to stir for 0.5 hour to obtain the homogeneous solution of cellulose nanofibrils and chitosan.

6) Adding the MXene solution in step 4) to the solution obtained in step 5), then at 25° C. to react for 0.5 hour to obtain the homogeneous solution of phosphorylated cellulose nanofibrils, chitosan and MXene.

7) The obtained composite solution is placed in the mold, putting in a vacuum oven at 50° C. to dry for 96 hour to prepare the high-strength flame-retardant MXene/phosphorylated cellulose nanofibrils composite film.

### Embodiment 3

1) The preparation method of phosphorylated cellulose nanofibril is as follows: using 12 g of cellulose pulp board as raw material, by mechanical grinding to obtain flocculent raw material, then adding 500 ml of deionized water, 22 g of diammonium hydrogen phosphate and 42 g of urea and mechanically stirring for 40 min, the obtained mixture is placed in the oven at 70° C. to dry, then at 150° C. to heat continuously for 10 min to cure, the cured product is dissolved in 1 L of deionized water, and using 1 mol/L of sodium hydroxide solution to adjust the pH of the solution to 11 and still standing for 1 hour. Subsequently, washing the product with deionized water several times to neutral, adjusting the concentration to 0.5 wt %, the suspension by using a centrifugal ultrafine grinder at 1500 rpm to grind to obtain nano-sized particles of phosphorylated cellulose nanofibrils.

2) At room temperature, adding 0.5 g of chitosan (the weight-average molecular weight is 10000, the degree of deacetylation is 90%) to 100 ml of acetic acid solution (0.2 vol %), continuously stirring for 0.5 hour, and then still standing.

3) By weight, at room temperature, adding 50 g of phosphorylated cellulose nanofibril aqueous solution to the container, adding 100 ml of deionized water to mix to form uniform solution.

4) By weight, at room temperature, adding 0.9 g of MXene to the container, and adding 9 ml of deionized water to mix to form uniform solution.

5) At room temperature, taking 102 ml of the blended solution of step 3), adding 6 ml of the chitosan solution of step 2) to stir for 0.5 hour to obtain the homogeneous solution of cellulose nanofibrils and chitosan.

6) Adding the MXene solution in step 4) to the solution obtained in step 5), then at 25° C. to react for 0.5 hour to obtain the homogeneous solution of phosphorylated cellulose nanofibrils, chitosan and MXene.

7) The obtained composite solution is placed in the mold, putting in a vacuum oven at 45° C. to dry for 96 hour to prepare the high-strength flame-retardant MXene/phosphorylated cellulose nanofibrils composite film.

### Embodiment 4

1) The preparation method of phosphorylated cellulose nanofibril is as follows: using 13 g of cellulose pulp board as raw material, by mechanical grinding to obtain flocculent raw material, adding 800 ml of deionized water, 25 g of diammonium hydrogen phosphate and 45 g of urea and mechanically stirring for 60 min, the obtained mixture is placed in the oven at 100° C. to dry, then at 180° C. to heat continuously for 30 min to cure, the cured product is dissolved in 1 L of deionized water, using 1 mol/L of sodium hydroxide solution to adjust the pH of the solution to 13 and still standing for 1 hour. Subsequently, washing the product with deionized water several times to neutral, and adjusting the concentration to 0.2 wt %, the suspension by using a centrifugal ultrafine grinder at 1500 rpm to grind to obtain nano-sized particles of phosphorylated cellulose nanofibrils.

2) At room temperature, adding 0.5 g of chitosan (the weight-average molecular weight is 22000, the degree of deacetylation is 78%) to 100 ml of acetic acid solution (3 vol %), continuously stirring for 0.5 hour, and then still standing.

3) By weight, at room temperature, adding 80 g of phosphorylated cellulose nanofibrils aqueous solution to the container, adding 150 ml of deionized water to mix to form uniform solution.

4) By weight, at room temperature, adding 2.7 g of MXene to the container, then adding 25 ml of deionized water to mix to form uniform solution.

5) At room temperature, taking 108 ml of the blended solution of step 3), adding 4 ml of the chitosan solution of step 2) to stir for 0.5 hour to obtain the homogeneous solution of cellulose nanofibrils and chitosan.

6) Adding the MXene solution in step 4) to the solution obtained in step 5), then at 25° C. to react for 0.5 hour to obtain the homogeneous solution of phosphorylated cellulose nanofibrils, chitosan and MXene.

7) The obtained composite solution is placed in the mold, putting in a vacuum oven at 50° C. to dry for 96 hour to prepare the high-strength flame-retardant MXene/phosphorylated cellulose nanofibrils composite film.

### Embodiment 5

1) The preparation method of phosphorylated cellulose nanofibril is as follows: using 14 g of cellulose pulp board as raw material, by mechanical grinding to obtain flocculent raw material, adding 700 ml of deionized water, 23 g of diammonium hydrogen phosphate and 43 g of urea and mechanically stirring for 50 min, the obtained mixture is placed in the oven at 80° C. to dry, then at 160° C. to heat continuously for 20 min to cure, the cured product is dissolved in 1 L of deionized water, using 1 mol/L of sodium hydroxide solution to adjust the pH of the solution to 13 and still standing for 2 hour. Subsequently, washing the product with deionized water several times to neutral, and adjusting the concentration to 0.5 wt %, the suspension by using a centrifugal ultrafine grinder at 1400 rpm to grind to obtain nano-sized particles of phosphorylated cellulose nanofibrils.

2) At room temperature, adding 0.5 g of chitosan (the weight-average molecular weight is 50000, the degree of deacetylation is 88%) to 75 ml of acetic acid solution (0.2 vol %), continuously stirring for 0.5 hour, and then still standing.

3) By weight, at room temperature, adding 80 g of phosphorylated cellulose nanofibrils aqueous solution to the container, and mixing it with 150 ml of deionized water to mix to form uniform solution.

4) By weight, at room temperature, adding 2.7 g of MXene to the container, then adding 15 ml of deionized water to mix to form uniform solution.

5) At room temperature, taking 108 ml of the blended solution of step 3), adding 4 ml of the chitosan solution of step 2) to stir for 0.5 hour to obtain the homogeneous solution of cellulose nanofibrils and chitosan.

6) Adding the MXene solution in step 4) to the solution obtained in step 5), then at 20° C. to react for 0.5 hour to obtain the homogeneous solution of phosphorylated cellulose nanofibrils, chitosan and MXene.

7) The obtained composite solution is placed in the mold, putting in a vacuum oven at 50° C. to dry for 72 h to prepare the high-strength flame retardant MXene/phosphorylated cellulose nanofibrils composite film.

### Embodiment 6

1) The preparation method of phosphorylated cellulose nanofibril is in accordance with Embodiment 3.

2) At room temperature, adding 0.5 g of chitosan (the weight-average molecular weight is 200000, the degree of deacetylation is 90%) to 100 ml of acetic acid solution (0.2 vol %), continuously stirring for 0.5 hour, and then still standing.

3) By weight, at room temperature, adding 50 g of phosphorylated cellulose nanofibrils aqueous solution to the container, adding 100 ml of deionized water to mix to form uniform solution.

4) By weight, at room temperature, adding 1.8 g of MXene to the container, adding 9 ml of deionized water to mix to form uniform solution.

5) At room temperature, taking 102 ml of the blended solution of step 3), adding 6 ml of the chitosan solution of step 2) to stir for 0.5 hour to obtain the homogeneous solution of cellulose nanofibrils and chitosan.

6) Adding the MXene solution in step 4) to the solution obtained in step 5), then at 25° C. to react for 0.5 hour to obtain the homogeneous solution of phosphorylated cellulose nanofibrils, chitosan and MXene.

7) The obtained composite solution is placing in the mold, putting in a vacuum oven at 45° C. to dry for 96 hour to prepare the high-strength flame-retardant MXene/phosphorylated cellulose nanofibrils composite film.

### Embodiment 7

1) The preparation method of phosphorylated cellulose nanofibril is as follows: using 10 g of cellulose pulp board as raw material, by mechanical grinding to obtain flocculent raw material, adding 800 ml of deionized water, 25 g of diammonium hydrogen phosphate and 45 g of urea and mechanically stirring for 60 min, the obtained mixture is placed in the oven at 100° C. to dry, then at 140° C. to heat continuously for 30 min to cure, the cured product is dissolved in 1 L of deionized water, using 1 mol/L of sodium hydroxide solution to adjust the pH of the solution to 10 and still standing for 2 hour. Subsequently, washing the product with deionized water several times to neutral, and adjusting the concentration to 0.5 wt %, the suspension by using a centrifugal ultrafine grinder at 1400 rpm to grind to obtain nano-sized particles of phosphorylated cellulose nanofibrils.

2) At room temperature, adding 0.5 g of chitosan (the weight-average molecular weight is 89000, the degree of deacetylation is 94%) to 100 ml of acetic acid solution (3 vol %), continuously stirring for 0.5 hour, and then still standing.

3) By weight, at room temperature, adding 40 g of phosphorylated cellulose nanofibrils aqueous solution to the container, then adding 100 ml of deionized water to mix to form uniform solution.

4) By weight, at room temperature, adding 4.5 g of MXene to the container, adding 10 ml of deionized water to mix to form uniform solution.

5) At room temperature, taking 96 ml of the blended solution of step 3), adding 8 ml of the chitosan solution of step 2) to stir for 0.5 hour to obtain the homogeneous solution of cellulose nanofibrils and chitosan.

6) Adding the MXene solution in step 4) to the solution obtained in step 5), then at 30° C. to react for 0.5 hour to obtain the homogeneous solution of phosphorylated cellulose nanofibrils, chitosan and MXene.

7) The obtained composite solution is placed in the mold, putting in a vacuum oven at 40° C. to dry for 80 hour to prepare the high-strength flame-retardant MXene/phosphorylated cellulose nanofibrils composite film.

### Embodiment 8

1) The preparation method of phosphorylated cellulose nanofibril is as follows: using 15 g of cellulose pulp board as raw material, by mechanical grinding to obtain flocculent raw material, adding 400 ml of deionized water, 20 g of diammonium hydrogen phosphate and 40 g of urea and mechanically stirring for 30 min, the obtained mixture is placed in the oven at 90° C. to dry, then at 170° C. to heat continuously for 25 min to cure, the cured product is dissolved in 1 L of deionized water, using 1 mol/L of sodium hydroxide solution to adjust the pH of the solution to 12 and still standing for 2 hour. Subsequently, washing the product with deionized water several times to neutral, and adjusting the concentration to 0.2 wt %, the suspension by using a centrifugal ultrafine grinder at 1300 rpm to grind to obtain nano-sized particles of phosphorylated cellulose nanofibrils.

2) At room temperature, adding 1.0 g of chitosan (the weight-average molecular weight is 40000, the degree of deacetylation is 77%) to 50 ml of acetic acid solution (2.5 vol %), continuously stirring for 0.5 hour, and then still standing.

3) By weight, at room temperature, adding 80 g of phosphorylated cellulose nanofibrils aqueous solution to the container, then adding 100 ml of deionized water to mix to form uniform solution.

4) By weight, at room temperature, adding 9.0 g of MXene to the container, then adding 9 ml of deionized water to mix to form uniform solution.

5) At room temperature, taking 102 ml of the blended solution of step 3), adding 6 ml of the chitosan solution of step 2) to stir for 0.5 hour to obtain the homogeneous solution of cellulose nanofibrils and chitosan.

6) Adding the MXene solution in step 4) to the solution obtained in step 5), then at 30° C. to react for 0.5 hour to obtain the homogeneous solution of phosphorylated cellulose nanofibrils, chitosan and MXene.

7) The obtained composite solution is placed in the mold, putting in a vacuum oven at 50° C. to dry for 72 hour to prepare the high-strength flame-retardant MXene/phosphorylated cellulose nanofibrils composite film.

### Embodiment 9

1) The preparation method of phosphorylated cellulose nanofibril is as follows: using 12 g of cellulose pulp board as raw material, by mechanical grinding to obtain flocculent raw material, adding 600 ml of deionized water, 20 g of diammonium hydrogen phosphate and 40 g of urea and mechanically stirring for 20 min, the obtained mixture is placed in the oven at 70° C. to dry, then at 170° C. to heat continuously for 20 min to cure, the cured product is dissolved in 1 L of deionized water, using 1 mol/L of sodium hydroxide solution to adjust the pH of the solution to 13 and still standing for 1 hour. Subsequently, washing the product with deionized water several times to neutral, and adjusting the concentration to 0.5 wt %, the suspension by using a centrifugal ultrafine grinder at 1200 rpm to grind to obtain nano-sized particles of phosphorylated cellulose nanofibrils.

2) At room temperature, adding 2.5 g of chitosan (the weight-average molecular weight is 280000, the degree of deacetylation is 89%) to 25 ml of acetic acid solution (2 vol %), continuously stirring for 0.5 hour, and then still standing.

3) By weight, at room temperature, adding 40 g of phosphorylated cellulose nanofibrils aqueous solution to the container, then adding 150 ml of deionized water to mix to form uniform solution.

4) By weight, at room temperature, adding 18 g of MXene to the container, then adding 10 ml of deionized water to mix to form uniform solution.

5) At room temperature, taking 90 ml of the blended solution of step 3), adding 10 ml of the chitosan solution of step 2) to stir for 0.5 hour to obtain the homogeneous solution of cellulose nanofibrils and chitosan.

6) Adding the MXene solution in step 4) to the solution obtained in step 5), then at 35° C. to react for 0.5 h to obtain the homogeneous solution of phosphorylated cellulose nanofibrils, chitosan and MXene.

7) The obtained composite solution is placed in the mold, putting in a vacuum oven at 45° C. to dry for 90 hour to prepare the high-strength flame-retardant MXene/phosphorylated cellulose nanofibrils composite film.

### Embodiment 10

1) The preparation method of phosphorylated cellulose nanofibril is as follows: using 13 g of cellulose pulp board as raw material, by mechanical grinding to obtain flocculent raw material, adding 700 ml of deionized water, 20 g of diammonium hydrogen phosphate and 40 g of urea and mechanically stirring for 50 min, the obtained mixture is placed in the oven at 40° C. to dry, then at 140° C. to heat continuously for 30 min to cure, the cured product is dissolved in 1 L of deionized water, using 1 mol/L of sodium hydroxide solution to adjust the pH of the solution to 10 and still standing for 1 hour. Subsequently, washing the product with deionized water several times to neutral, and adjusting the concentration to 0.2 wt %, the suspension by using a centrifugal ultrafine grinder at 1200 rpm to grind to obtain nano-sized particles of phosphorylated cellulose nanofibrils.

2) At room temperature, adding 0.5 g of chitosan (the weight-average molecular weight is 250000, the degree of deacetylation is 96%) to 50 ml of acetic acid solution (0.2 vol %), continuously stirring for 0.5 hour, and then still standing.

3) By weight, at room temperature, adding 80 g of phosphorylated cellulose nanofibril aqueous solution to the container, then adding 130 ml of deionized water to mix to form uniform solution.

4) By weight, at room temperature, adding 22.5 g of MXene to the container, then adding 10 ml of deionized water to mix to form uniform solution.

5) At room temperature, taking 90 ml of the blended solution of step 3), adding 10 ml of the chitosan solution of step 2) to stir for 0.5 hour to obtain the homogeneous solution of cellulose nanofibrils and chitosan.

6) Adding the MXene solution in step 4) to the solution obtained in step 5), then at 20° C. to react for 0.5 hour to obtain the homogeneous solution of phosphorylated cellulose nanofibrils, chitosan and MXene.

7) The obtained composite solution is placed in the mold, putting in a vacuum oven at 20° C. to dry for 72 hour to prepare the high-strength flame-retardant MXene/phosphorylated cellulose nanofibrils composite film.

It should be noted that each embodiment in the present application is described in a progressive manner, and each embodiment focuses on the differences with other embodiments. The same and similar parts of each embodiment can be referred to each other. For the method disclosed by embodiments, because it corresponds to the method disclosed by embodiments, the description is relatively simple, and the relevant points can be described in the method section.

In order to further illustrate the excellent effect of the high-strength flame retardant MXene/phosphorylated cellulose nanofibril composite film envisaged by the present application, the following comparative experiments are carried out.

### Comparative Example 1

1) According to the method in Embodiment 3 to prepare phosphorylated cellulose nanofibril.

2) By weight, at room temperature, adding phosphorylated cellulose nanofibrils aqueous solution to the container, then adding 150 ml of deionized water to mix to form uniform solution.

3) At room temperature, taking 102 ml of the composite solution obtained in step 2) at room temperature to place in the mold, putting in a vacuum oven at 45° C. to dry for 96 hour to prepare the film material (PCNF film).

### Comparative Example 2

1) According to the method in Embodiment 3 to prepare phosphorylated cellulose nanofibrils.

2) Adding chitosan (the weight-average molecular weight is 200000, the degree of deacetylation is 90%) to 100 ml of acetic acid solution (0.2 vol %) at room temperature, and continuously stirring for 0.5 hour, and then still standing.

3) By weight, at room temperature, adding phosphorylated cellulose nanofibril aqueous solution to the container, then adding 100 ml of deionized water to mix to form uniform solution.

4) At room temperature, taking 102 ml of the obtained solution of step 3), adding 6 ml of the chitosan solution of step 2) to stir for 1 hour to obtain homogeneous solution of cellulose nanofibrils and chitosan.

5) The obtained composite solution is placed in the mold, putting in a vacuum oven at 45° C. to dry for 96 hour to prepare the film material.

### Comparative Example 3

1) According to the method in Embodiment 3 to prepare phosphorylated cellulose nanofibrils.

2) By weight, at room temperature, adding phosphorylated cellulose nanofibrils aqueous solution to the container, then adding 100 ml of deionized water to mix to form uniform solution.

3) By weight, at room temperature, adding 0.9 g of MXene to the container, and adding 9 ml of deionized water to mix to form uniform solution.

4) At room temperature, taking 102 ml of the obtained solution of step 2) to the MXene solution of step 3), then at 25° C. to react for 0.5 hour to obtain homogeneous solution of phosphorylated cellulose nanofibrils and MXene.

5) The obtained homogeneous solution is placed in the mold, putting in a vacuum oven at 45° C. to dry for 96 hour to obtain the composite film.

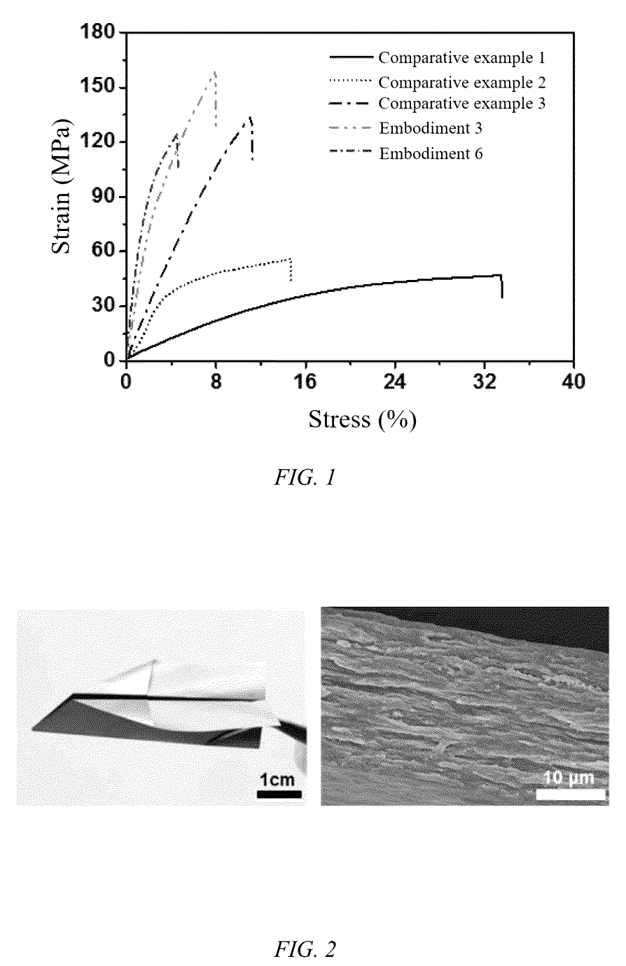

FIG. 1 shows the stress-strain curves of the composite film for Comparative example 1-3, Embodiment 3 and 6 of the present application. According to the calculation results, compared with the ratio, the composite film prepared by Embodiment 3 has excellent mechanical property, the tensile strength, the elongation at break, the elasticity modulus and the breaking energy can respectively reach to 159.3 MPa, 7.9%, 4.2 GPa and 8.1 MJ·m⁻³; especially, the tensile strength and elastic modulus are significantly higher than the chitosan composite film of Comparative example 3 (the tensile strength: 55.2 MPa, the elasticity modulus: 0.9 GPa), and the mechanical properties of the film prepared by Comparative example 1 are poor, especially the tensile strength and elastic modulus are much lower than the composite film. Those shows that the introduction of chitosan and MXene is helpful to construct a strong hybrid network structure of the composite film, thereby improving their mechanical properties. In addition, excessive MXene resulted in a downward trend in mechanical properties (Embodiment 6, the tensile strength: 124.2 MPa). Therefore, suitable nanomaterials are one of the key factors to obtain high mechanical properties of the composite film.

FIG. 2 shows digital photographs and cross-section SEM of the high-strength flame-retardant MXene/phosphorylated cellulose fibril composite film synthesized in Embodiment 3. As shown in FIG. 2 that the composite film can carry out complex folding and form a paper airplane without mechanical damage, which indicates that the high-strength flame-retardant composite film of the present application has excellent flexibility and deformability, and further confirms its excellent mechanical properties.

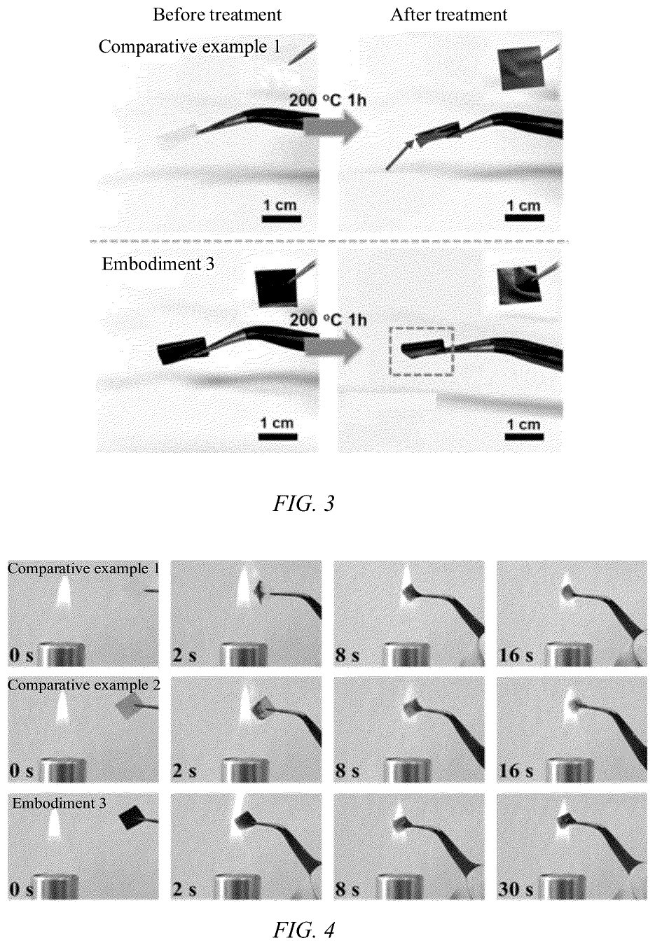

FIG. 3 shows the comparative digital photographs of high-temperature treatment of high-strength flame retardant MXene/phosphorylated cellulose fibril composite film synthesized by Embodiment 3 and Comparative example 1. As shown in FIG. 3, there is a significant difference between the macroscopic properties before and after high temperature treatment of Comparative example 1 and Embodiment 3, the introduction of chitosan and MXene significantly improves the resistance to elevated temperatures of the composite film, that is, the film has no obvious appearance change and still shows excellent flexibility after treatment for 1 hour at 200° C. In contrast, the film changes from colorless and transparent to brown-yellow and breaks during the folding process, which indicates that chitosan and MXene can effectively protect cellulose nanofibrils and reduce the damage and destruction of its skeleton caused by high temperature. In addition, through the combustion test of Comparative example 1, Comparative example 2 and Embodiment 3 (FIG. 4), it can be found that although the pure PCNF film can also maintain the stability and integrity of the structure during the combustion process, there is an obvious flame during the combustion process, and the introduction of chitosan has the elevating effect. It is worth noting that the composite film can form synergistic flame-retardant effect with phosphorous groups due to the introduction of MXene, and further protect the polymer skeleton on the basis of chitosan, therefore there is no obvious flame in the combustion process. This is an extremely important performance for suppressing flame spread in practical applications.

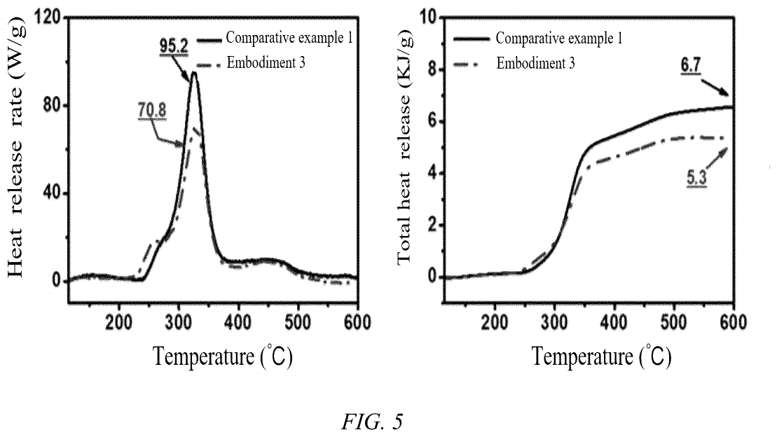

FIG. 5 shows the heat release rate and total heat release of high-strength flame-retardant MXene/phosphorylated cellulose fibril composite film synthesized from Comparative example 1 and Embodiment 3. The two values of Embodiment 3 are significantly lower than that of Comparative example 1 as shown in FIG. 5, indicating that the former has better flame-retardant performance.

The above results indicate that the product of the present application has potential practical application prospects as high-performance flame-retardant coating. The product of the present application can be film for direct or composite use. Further, using the homogeneous solution of phosphorylated cellulose nanofibril, chitosan and MXene of the present application as a coating precursor, spraying to the substrate and drying to obtain flame retardant coating.

The above description of the disclosed embodiments enables persons skilled in the art to realize or use the present application. Various modifications to these embodiments will be apparent to those skilled in the art, and the general principles defined herein may be realized in other embodiments without departing from the spirit or scope of the present invention. Therefore, the present application will not be limited to these embodiments shown herein, but will conform to the widest range consistent with the principles and novel features disclosed herein.

1. A method of preparing a high-strength flame-retardant MXene/phosphorylated cellulose fibril composite film, comprising the following steps:
mixing a phosphorylated cellulose nanofibril solution with a chitosan solution;
adding an MXene solution to obtain a precursor solution; and
preparing the precursor solution into a film to obtain the high-strength flame retardant MXene/phosphorylated cellulose fibril composite film.

2. The method of preparing the high-strength flame-retardant MXene/phosphorylated cellulose fibril composite film according to claim 1, wherein the solvent in the chitosan solution is acetic acid or hydrochloric acid aqueous solution, and the concentration of the solvent is 0.2-3.0 vol %; the solvent in the phosphorylated cellulose nanofiber solution and the MXene solution is water.

3. The method of preparing the high-strength flame-retardant MXene/phosphorylated cellulose fibril composite film according to claim 1, wherein the mass ratio of chitosan, phosphorylated cellulose nanofibril and MXene is (1-10):(10-50):(50-200).

4. The method of preparing the high-strength flame-retardant MXene/phosphorylated cellulose fibril composite film according to claim 1, wherein the molecular weight of the chitosan is 500-350000, and the degree of deacetylation is 75-98%.

5. The method of preparing the high-strength flame retardant MXene/phosphorylated cellulose fibril composite film according to claim 1, wherein using titanium carbide aluminum as raw material to prepare the MXene; using cellulose pulp board, phosphate and organic nitrogen compounds as raw material to prepare the phosphorylated cellulose nanofibrils.

6. The method of preparing the high-strength flame-retardant MXene/phosphorylated cellulose fibril composite film according to claim 5, wherein using titanium-carbide aluminum as raw material, and in the presence of the lithium fluoride and hydrochloric acid to prepare the MXene; the phosphate is one of disodium hydrogen phosphate, diammonium hydrogen phosphate and dipotassium hydrogen phosphate or a combination thereof.

7. The method of preparing the high-strength flame-retardant MXene/phosphorylated cellulose fibril composite film according to claim 1, wherein mixing the phosphorylated cellulose nanofibril solution with the chitosan solution for 0.1-1 hour, then adding the MXene solution and reacting at 20-30° C. for 0.1-1 h to obtain the precursor solution; the precursor solution is then vacuum-dried to form a film to obtain a high-strength flame-retardant MXene/phosphorylated cellulose fibril composite film.

8. A high-strength flame-retardant MXene/phosphorylated cellulose fibril composite film prepared by the method of claim 1.

9. An application of the high-strength flame-retardant MXene/phosphorylated cellulose fibril composite film described in claim 8 in the preparation of flame-retardant materials.

10. An application of the precursor solution according to claim 1 in the flame retardant coatings.
